(19) United States
(12) Patent Application Publication
(10) Pub. No.: US 2024/0373820 A1
(43) Pub. Date: Nov. 14, 2024

(54) DOG-RESISTANT CAT FEEDING STATION

(71) Applicant: Dillon Deaner, Morrisville, NY (US)

(72) Inventor: Dillon Deaner, Morrisville, NY (US)

(21) Appl. No.: 18/782,378

(22) Filed: Jul. 24, 2024

Related U.S. Application Data
(63) Continuation-in-part of application No. 18/076,769, filed on Dec. 7, 2022.

(51) Int. Cl. A01K 5/01; A01K 1/035

(52) U.S. Cl. CPC A01K 5/0142; A01K 1/0356

(57) ABSTRACT

A cat feeding station includes first and second floors surrounded by sidewalls and a roof. An access opening for a cat is provided in the sidewall and a second access opening is provided through the second floor to give a cat access to the second floor. A hatch (covered by a door) is formed through the roof and provides access to the second floor for the pet owner to place a bowl of food/water through and set onto the second floor. The cat feeding station uses fastening elements for easy assembly and disassembly for shipping and storage.

### CROSS-REFERENCE TO RELATED APPLICATIONS

This application is a continuation-in-part of, and claims priority to, U.S. patent application Ser. No. 18/076,769, filed on Dec. 7, 2022, entitled CAT FEEDING STATION, the contents of which are hereby incorporated by reference in their entirety.

### FIELD OF THE INVENTION

The present disclosure is directed generally to cat feeders.

### BACKGROUND

Cats and dogs are often fed out of bowls placed on the floor in a designated area that the pet becomes accustomed to understanding as the location where it can eat. Households with cats and dogs or cats and other animals often experience the dog or other animal eating the cat's food when left in a bowl on the floor, thus leaving the cat without any food in its dish when it decides it would like to eat.

Accordingly, there is a need in the art for a cat feeding station that prevents dogs or other animals from accessing and eating the cat's food.

### SUMMARY

The present disclosure is directed to cat feeding stations.

According to an aspect is a cat feeding station, comprising a housing having a first floor and a second floor that extends in vertically spaced, parallel relation above the first floor, sidewalls that extend around the first and second floors, and a roof that is positioned atop and in contacting relation to the sidewalls and in vertically spaced relation above the second floor; wherein, the sidewalls include a first cutout region of predetermined dimensions that provides interior access to the first floor; wherein the second floor includes a second cutout region formed therethrough in a predetermined location and being of predetermined dimensions and that provides access to the second floor from the first floor; wherein, the roof includes a hatch formed therethrough in a predetermined location that is not vertically aligned with the second cutout region and that provides access to the second floor through the roof; whereby, a user can place cat food on the second floor via the hatch and a cat can access the food by entering the station through the first cutout region and accessing the second floor through the second cutout region.

According to an embodiment, the housing is linear in shape.

According to an embodiment, the housing is L-shaped.

According to an embodiment, the sidewalls further include a third cutout region of predetermined dimensions that provides interior access to the first floor; the second floor further includes a fourth cutout region formed therethrough in a predetermined location and being of predetermined dimensions and that provides access to the second floor from the first floor; the roof further includes a second hatch formed therethrough in a predetermined location that is not vertically aligned with the second or fourth cutout regions and that provides access to the second floor through the roof; whereby, a user can place cat food on the second floor via the hatch and second hatch and a cat can access the food by entering the station through the first or third cutout regions and accessing the second floor through the second or fourth cutout regions.

According to an embodiment, the cat feeding station further comprises at least one feed bowl that is oblong in shape.

According to an embodiment, the cat feeding station further comprises at least one feed bowl having magnetic properties.

According to an embodiment, the cat feeding station further comprises holes in the roof and the first floor sized and shaped to accept the slats.

According to an embodiment, the holes in the first floor of the cat feeding station have a different geometry than the holes in the roof of the cat feeding station.

According to an embodiment, the slats of the cat feeding station have protrusions on the top and bottom ends sized and shaped to fit into the holes in the roof and first floor.

According to an embodiment, the protrusions on the top end of the slats are a different geometry than the protrusions on the bottom end of the slats.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIG. 1 is a perspective view of a linear cat feeding station, in accordance with an embodiment.

FIG. 2 is a partial side elevation view of an L-shaped cat feeding station, in accordance with an embodiment.

FIG. 3 is an upper perspective view of a L-shaped cat feeding station, in accordance with an embodiment.

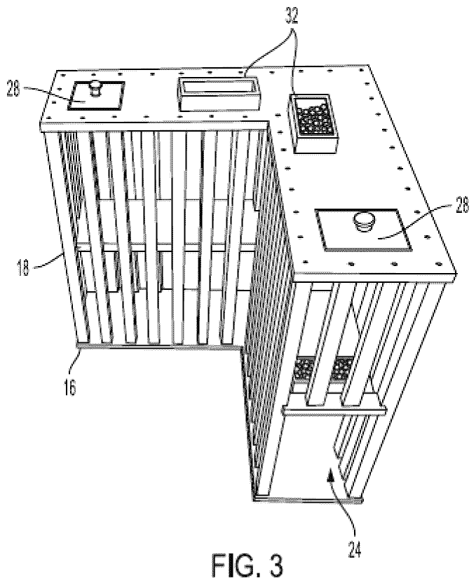

FIG. 4 is a partial side elevation view of an L-shaped cat feeding station, in accordance with an embodiment.

FIG. 5 is an upper perspective view of a liner and a L-shaped cat feeding station, in accordance with an embodiment.

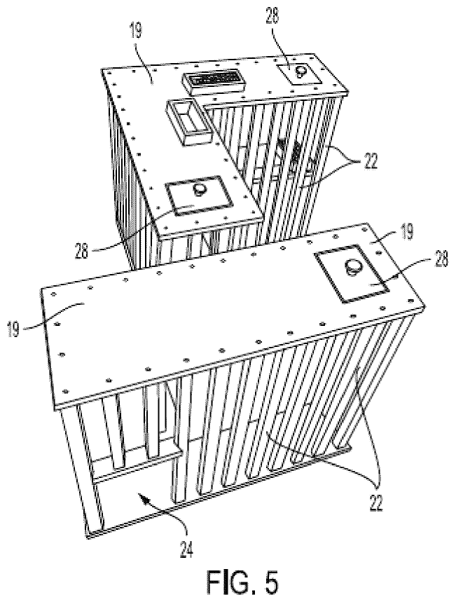

FIG. 6 is a cross-sectional view taken along section line 6-6 of FIG. 1.

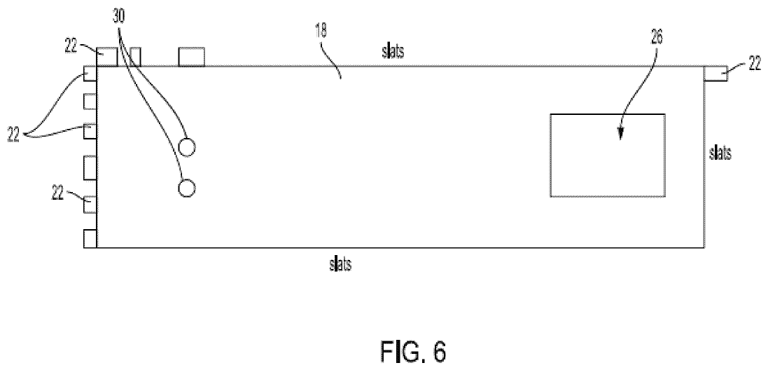

FIG. 7 is a perspective view of an exemplary cat feeding station.

FIG. 8 is a partial top-down view of an exemplary cat feeding station.

FIG. 9 is a top-down view of an exemplary cat feeding station.

FIG. 10 is a front view of slats for an exemplary cat feeding station.

FIGS. 11A-11B are views of ends of slats for an exemplary cat feeding station.

FIGS. 12A-12B are views of post holes for slats for an exemplary cat feeding station.

### DETAILED DESCRIPTION OF EMBODIMENTS

The present disclosure describes a cat feeding station.

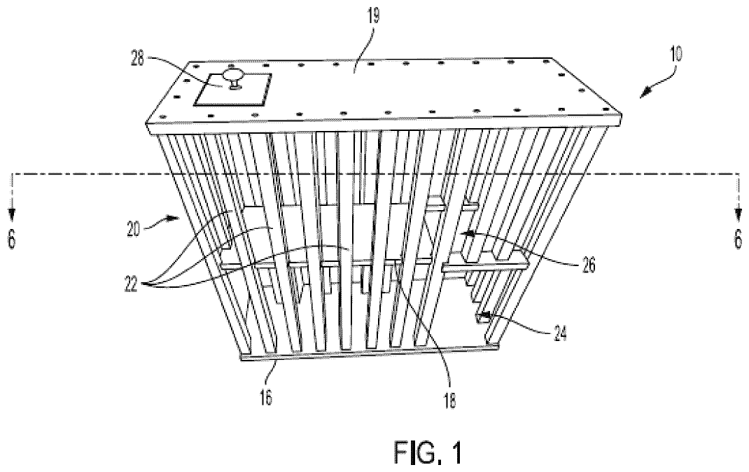

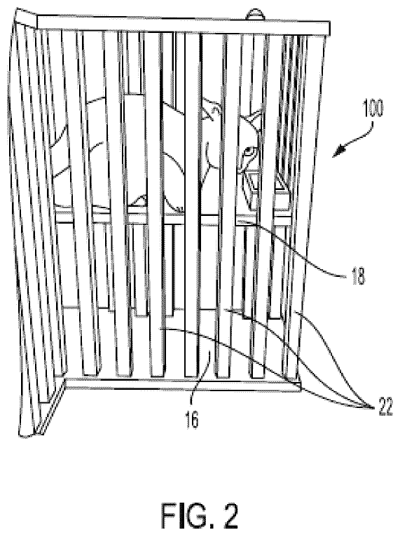

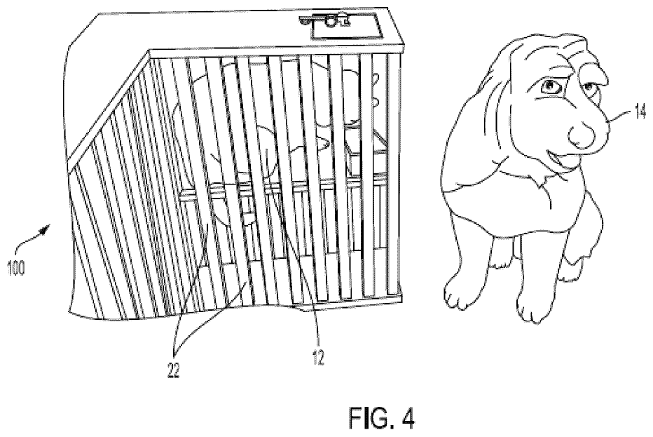

Referring to FIG. 1, in one embodiment, is a linear cat feeding station 10 designed to permit a cat 12 to feed whenever it desires without another animal 14 (see FIG. 4) accessing and eating the food. Referring to FIG. 2, in another embodiment, is a L-shaped cat feeding station 100 which for all functional purposes is identical to cat feeding station 10, just providing for two feeding areas instead of one. The features of feeding stations 10 and 100 will be referred to using common reference numerals for like parts.

Feeding station 10 (100) includes a ground floor 16, a second floor 18 vertically spaced in parallel relation above the ground floor 16, sidewalls 20 comprised of laterally spaced slats 22 surrounding the ground floor 16 and second floor 18, and a roof 19 that attaches to the top of sidewalls 20/slats 22 and which extends in spaced relation above second floor 18, preferably parallel spaced relation.

A cut-out 24 is formed in one sidewall 20 to provide access to ground floor 16 (a second cut-out is formed in the L-shaped feeder 100). The dimensions of cut-out 24 is suitable for allowing passage of a cat therethrough but too small for larger animals, preferably about 6.5 to 7.5 inches square. Once cat enters through cut-out 24, the cat may then hop through a second cut-out 26 formed through second floor 18 and which thus provides access to the second floor by way of the cat hopping up and through the cut-out (there is a second cut-out formed through the second floor in the L-shaped feeder 100). This cut-out 26 is also about 6.7 to 7.5 inches square.

A door 28 is provided on roof 19 and when opened provides access to the second floor 18 via a hatch. Door 28/hatch is positioned is non-vertically aligned position, preferably on the opposite side of second floor, from cut-out 26. A pet owner may open door 28 and place a bowl of food/water on second floor 18 which the cat may then access through its entry onto second floor 18 through cut-outs 24 and 26. L-shaped feeder 100 includes two doors, one on each end of each leg of the L-shaped, thus providing two spaces to place a cat bowl. The hatch to which door 28 provides access is about 3.5×4.5 inches.

An additional aspect are magnets 30 incorporated into the second floor 18 in the area where feed bowls are to be placed, and then magnets (and/or metal material) incorporated into feed bowls 32 to permit secure placement of the feed bowls on the second floor, making it difficult for the cat to move the feed bowl (and perhaps pushing it through cut-out 26 and making it fall to the first floor). Further, specially shaped feed bowls 32 that are oblong in shape (e.g., rectangular) will provide a bowl that is more difficult for a cat to push through the feed station.

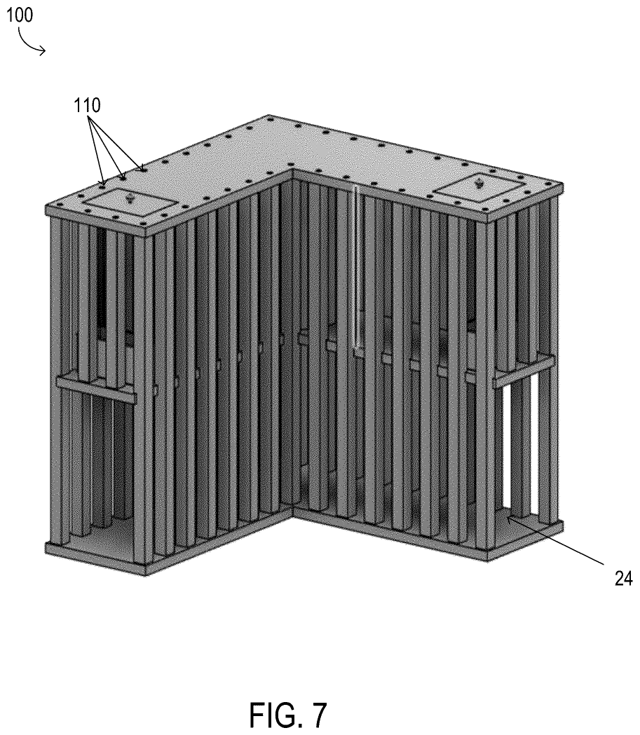

Referring now to FIG. 7, an exemplary embodiment of a feeder 100 can be easily disassembled and reassembled for shipping and storing. The feeding station 100 has multiple fastening elements 110 connecting the slats 22 with the ground floor 16 and roof 19. The fastening elements can be bolts, screws, snaps, pegs, or any other suitable element for connecting the slats 22 to the roof 19 and ground floor 16.

By connecting the ground floor 16 to the roof 19 with slats 22 held in place by fastening elements 110, the feeder 100 may be easily disassembled for shipping. For example, the feeder 100 may break down into individual pieces for the ground floor 16, second floor 18, roof 19, slats 22, and fastening elements 110. This allows for the feeder 100 to be flat packed for easy storage and shipping. After purchase, the feeder 100 may be assembled by a user by securing the slats 22 to the ground floor 16 using fastening elements 110. After the slats 22 are assembled, the second floor 18 may be slid into place above the ground floor 16. Half slats 120 may be secured to the second floor 18 above the cut outs 26 to provide further support to the roof 19. Next, the roof 19 may be placed on top of the slats 22 and secured with fastening elements 110 to complete assembly.

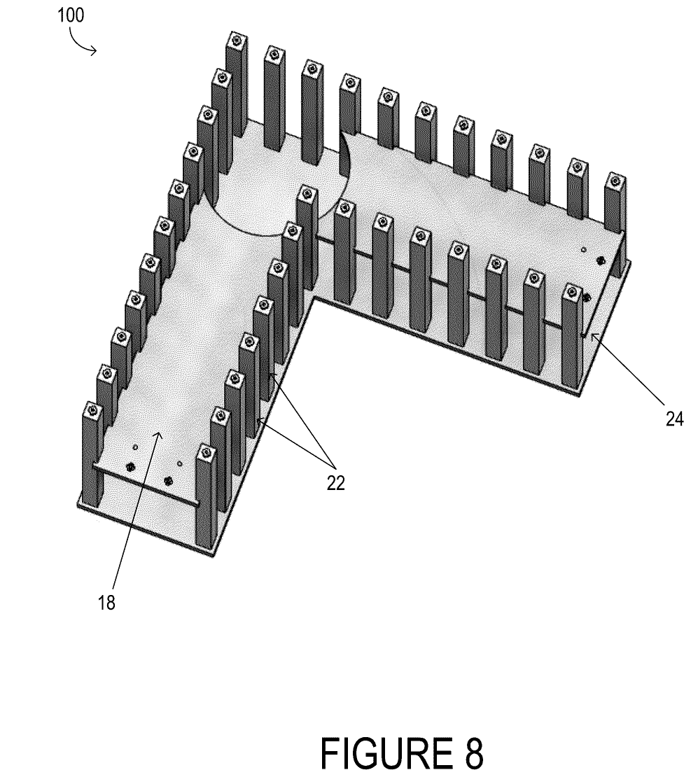

FIG. 8 depicts a cutaway top-down view of an exemplary feeder 100 having two doors 26 from the roof 19 to the second floor 18. In FIG. 8, the roof 19 is hidden for clarity, showing the second floor 18. Top-down views of the slats 22 connecting the ground floor 16 to the roof 19 are visible. As explained above, the doors 26 give access to the second floor 18 for placement of the bowls 32.

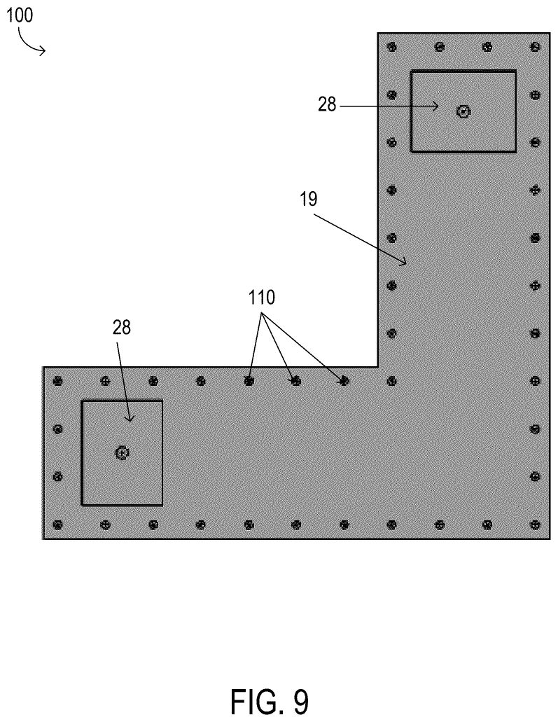

FIG. 9 depicts a top-down view of an exemplary feeder 100 showing the roof 19 connected to the slats 22 by fastening elements 110. The fastening elements 110 are positioned around the perimeter of the roof 19 with each fastening element 110 corresponding to a slat 22.

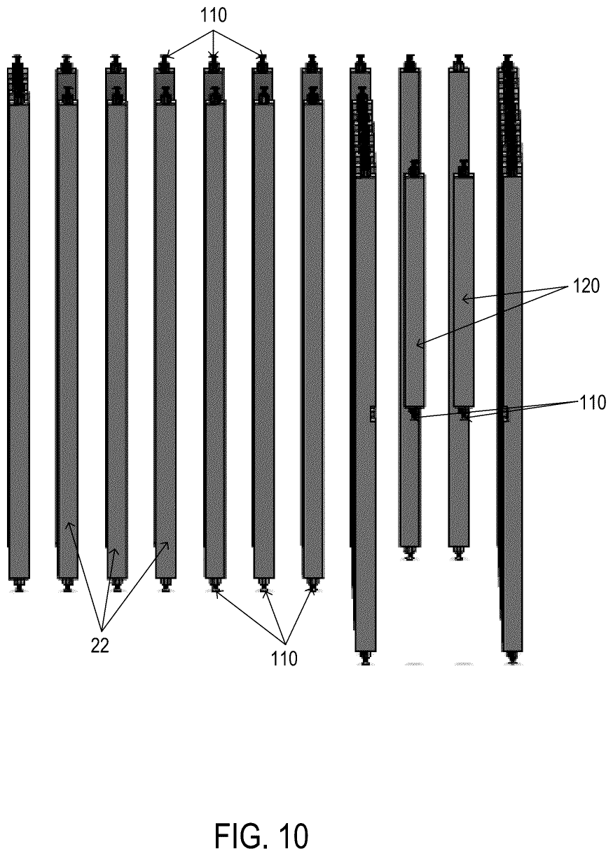

FIG. 10 depicts an arrangement of slats 22 as they would be oriented in an assembled feeder 100. For clarity, the roof 19, second floor 18, and ground floor 16 are not shown. Each slat 22 is secured in place at the roof 19 end and ground floor 16 end of the slat 22 by a fastening element 110. Half slats 120 are shown for securing the roof 19 to the second floor 18 above the cut outs 26.

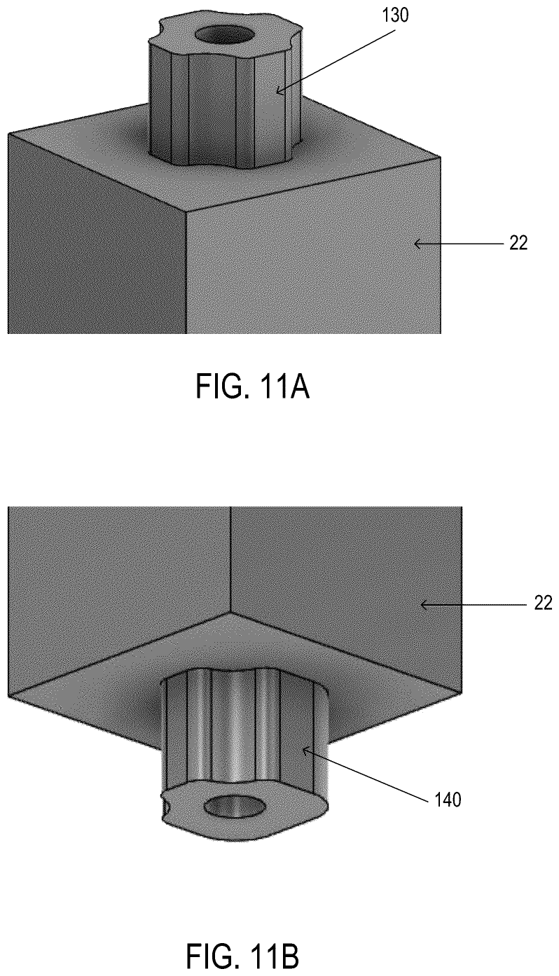

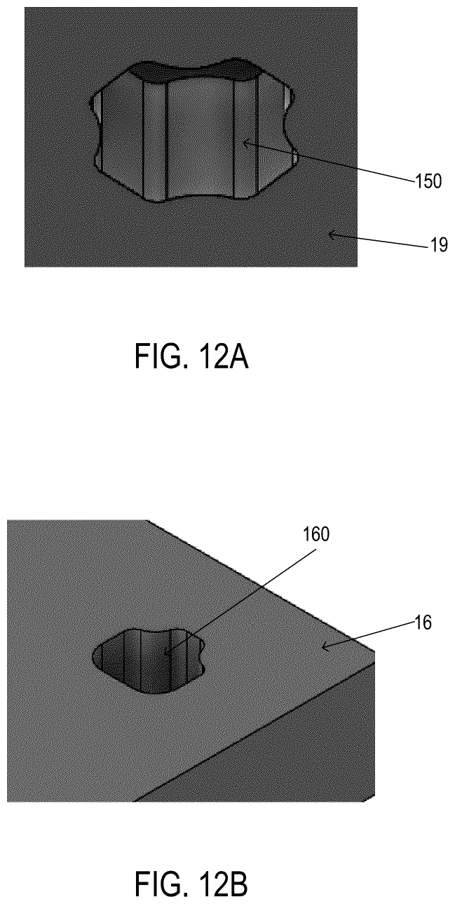

FIGS. 11A-11B depict the top (FIG. 11A) and bottom (FIG. 11B) geometries of the slats 22. For ease of assembly, the ends of the slats 22 have protrusions 130, 140 for fitting into corresponding holes 150, 160 (shown in FIGS. 12A-12B) in the roof 19 and ground floor 16. The protrusion 130 on the top end of the slat 22 (FIG. 11A) is differently shaped than the protrusion 140 on the bottom end of the slat 22 (FIG. 11B) to ensure that the slat 22 is oriented properly during assembly. After situating the slats 22 in the corresponding holes 150, 160 of the roof 19 (FIG. 12A) and the ground floor 16 (FIG. 12B), the slats 22 can be secured with a fastening element 110. This ensures proper assembly of the feeder 100.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A cat feeding station, comprising:
a housing having a first floor and a second floor that extends in vertically spaced, parallel relation above the first floor, sidewalls that extend around the first and second floors, and a roof that is positioned atop and in contacting relation to the sidewalls and in vertically spaced relation above the second floor;
wherein the sidewalls comprise slats in contact with the first floor and the roof;
wherein the first floor comprises holes sized and shaped to accept the slats;
wherein the roof comprises holes sized and shaped to accept the slats;
wherein the slats are secured to the first floor and the roof by a fastening element;
wherein, the sidewalls include a first cutout region of predetermined dimensions that provides interior access to the first floor;
wherein, the second floor includes a second cutout region formed therethrough in a predetermined location and being of predetermined dimensions and that provides access to the second floor from the first floor;
wherein, the roof includes a hatch formed therethrough in a predetermined location that is not vertically aligned with the second cutout region and that provides access to the second floor through the roof;
whereby, a user can place cat food on the second floor via the hatch and a cat can access the food by entering the station through the first cutout region and accessing the second floor through the second cutout region.

2. The cat feeding station according to claim 1, wherein the holes on the first floor have a different geometry than the holes on the roof.

3. The cat feeding station according to claim 1, wherein each slat comprises a protrusion on a top end and a bottom end;
wherein the protrusion on the top end is sized and shaped to be inserted into a hole on the roof, and
wherein the protrusion on the bottom end is sized and shaped to be inserted into a hole on the first floor.

4. The cat feeding station according to claim 3, wherein the protrusions on the top end of the slats have a different geometry than the protrusions on the bottom end of the slats.
